(19) United States
(12) Patent Application Publication
(10) Pub. No.: US 2005/0082810 A1
(43) Pub. Date: Apr. 21, 2005

(54) Automotive guard pipe

(75) Inventors: Tsuyoshi Chou, Saitama (JP); Kunio Miyauchi, Saitama (JP); Atsushi Ohba, Saitama (JP); Hironao Saito, Saitama (JP)

Correspondence Address: David W. Heid;MacPHERSON KWOK CHEN & HEID LLP, Suite 226, 1762 Technology Drive, San Jose, CA, 95110, US

(73) Assignee: HONDA MOTOR CO., LTD., Tokyo (JP)

(21) Appl. No.: 10/955,799

(22) Filed: Sep. 29, 2004

(30) Foreign Application Priority Data
Oct. 16, 2003 (JP) P.2003-355809

(51) Int. Cl. B60R 1/00

(52) U.S. Cl. 280/770

(57) ABSTRACT

A rod-like body made of a rubber material having an outside diameter which is substantially equal to the inside diameter of the guard pipe or an unexpanded resin material having a quality that the resin material expands sufficiently when heated in a paint baking process for the guard pipe is inserted, as a vibration damping material, into the interior of the guard pipe before the pipe is worked. Due to this, since the guard pipe can be made difficult to vibrate without making any substantial changes to the conventional vehicle body structure, the invention is effective in reducing noise generated while a vehicle is running without entraining a remarkable increase in production costs.

### BACKGROUND OF THE INVENTION

The present invention relates to an automotive guard pipe, and more particularly to a guard pipe for preventing a structure such as a fuel tank provided underneath the floor of a vehicle body from touching an object protruding from the surface of a road to be damaged.

As a means for preventing a portion of a structure such as a fuel tank provided underneath the floor of a vehicle body which protrudes downwardly from an underside of a floor panel of the vehicle body from touching an object protruding from the road surface to be damaged while a vehicle is running, there has been known a construction in which a metal pipe cut to an appropriate length is bent substantially into a U-shape for example, end portions of the pipe so cut are collapsed to form flat portions, and the flat portions so formed are bolted to the underside of the floor (refer to page 6-A-105 of a non-patent literature No. 1).

[Non-patent Literature No. 1]

Service Manual for HONDA ODYSSEY issued in December, 1999

In a guard pipe like one described above, since it is hollow, there has been sometimes caused a case where a resonance phenomenon is generated due to vibrations generated while a vehicle is running, whereby quietness is badly damaged. While the occurrence of such a resonance phenomenon in normal driving speeds can be suppressed to some extent by adjusting the undamped natural frequency (resonance frequency) of the guard pipe by properly setting the position and number of fixing points of the guard pipe relative to the vehicle body or the overall length thereof, in reality, this has had to entrain problems that the degree of freedom in design is disrupted due to the countermeasures against the resonance phenomenon and that the weight of the vehicle and the number of man-hours for assembling work are increased, that is, the production costs are increased remarkably as the number of structural members are increased to incorporate the countermeasures.

### SUMMARY OF THE INVENTION

With a view to providing a guard pipe which can solve the problems and reduce the amplitude resulting when resonance occurs without adding any other structural members, according to the invention, a rod-like body (a round rod body 12) of a rubber material which has an outside diameter substantially equal to the inside diameter of a pipe material 11 which constitutes the guard pipe 1 or an unexpanded resin material 15 having a quality that the resin material expands sufficiently when heated in the paint baking process of the guard pipe is inserted into the interior of the pipe material before it is worked.

According to the construction of the invention, since the vibration energy of the guard pipe is absorbed (damped) by virtue of the viscous resistance of the rubber material inserted into the guard pipe or the expanded resin material that is filled in the guard pipe when heated in the paint baking process, the guard pipe can be made difficult to vibrate without adding any substantial changes to the conventional vehicle body structure. Consequently, according to the invention, a tremendous advantage can be provided in reducing noise generated while the vehicle is running without entraining any remarkable increase in production costs.

### BRIEF DESCRIPTION OF THE DRAWINGS

FIG. 1 is a perspective view of a main part of a vehicle body as viewed from therebelow where a guard pipe to which the invention is applied is provided. (Embodiment 1)

FIG. 2 is a cross-sectional view illustrating a state where a pipe material is inserted into a round rod body. (Embodiment 1)

FIG. 3 is a cross-sectional view illustrating a state where ends of the pipe material are collapsed. (Embodiment 1)

FIG. 4 is a perspective view showing a part of a guard pipe as a single body.

FIG. 5 is a cross-sectional view of a guard pipe according to another embodiment. (Embodiment 2)

### DETAILED DESCRIPTION OF THE PREREERED EMBODIMENTS

Hereinafter, the invention will be described in detail by reference to the accompanying drawings.

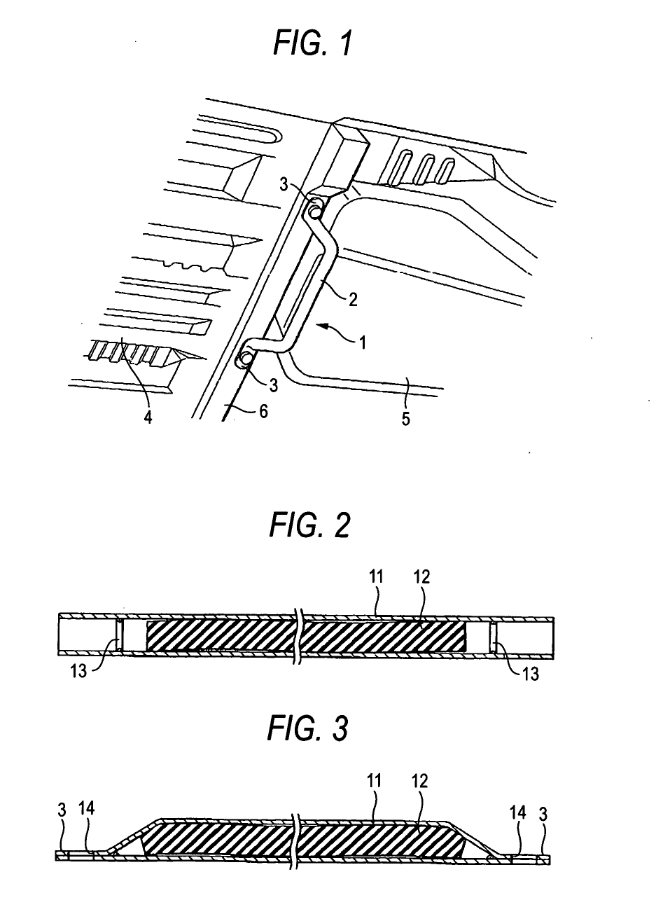

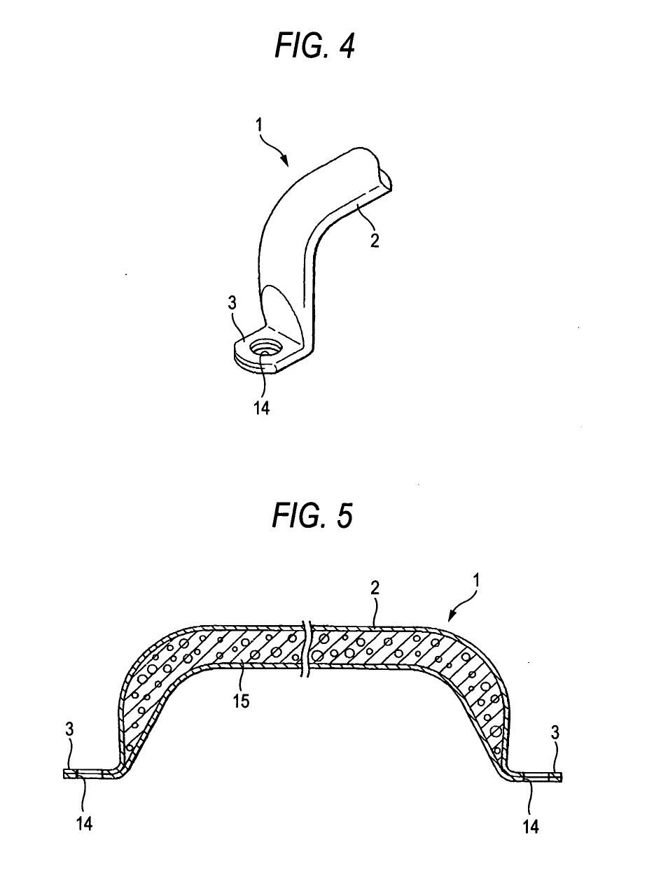

FIG. 1 shows an underside of a vehicle body provided with a guard pipe that is constructed based on the invention. This guard pipe 1 is formed by bending a steel pipe of a suitable diameter and has a substantially U-shaped main portion 2 and bolt fastening portions 3 formed at ends of the main portion 2 by collapsing the relevant portions of the pipe flat. This guard pipe 1 is fixed to an underside of a cross member 6 which is provided to extend transversely at a position next to the front of a fuel tank 5 placed in such a manner as to protrude downwardly of a floor panel 4 of the vehicle body, whereby the fuel tank 5 is protected from touching the ground while a vehicle is running.

### Embodiment 1

As shown in FIG. 2, a round rod body 12 (a vibration damping material) formed of a rubber material is inserted into the interior of a straight pipe material 11 which has not yet been worked. Here, since an inner circumferential surface of the pipe material 11 is not necessarily smooth and the friction coefficient on the surface of the round rod body 12 made of the rubber material is relatively high, the dimensions of the both members are set such that the outside diameter of the round rod body 12 loosely fits in the inside diameter of the pipe material 11. In addition, the insertion amount of the round rod body 12 is determined appropriately by regulating the push amount of an inserting tool.

While the round rod body 12 may be sold or a hollow thick tube-like structure, the round rod body 12 is reformed into a curved shape when vulcanized. Since a suitable holding force is exerted within the straight pipe material 11 due to this reformation to thereby prevent the round rod body 12 from coming off the pipe material 11, there is caused no risk that the position of the round rod body 12 is deviated relative to the pipe material 11 during transportation.

After the round rod body 12 has been inserted into the interior of the pipe material 11, a sealer 13 is applied to inner circumferential surfaces of end portions of the pipe material 11, the end portions are then collapsed to become flat with a pressing machine, and a bolt hole 14 is opened in a central portion of each of the end portions made so flat (refer to FIG. 1). The ingress of water from the distal end portions of the pipe material 11 where the bolt holes 14 are opened is prevented by the application of the sealer 13. Then, the pipe material 11 is worked to be bent into a predetermined shape with a bending machine, the pipe material 11 so bent is then painted with a cationic paint, and the pipe material 11 so painted is finally heated in a baking booth to obtain a completed product (refer to FIG. 1).

According to a guard pipe so completed, when the round rod body 12 made of the rubber material vibrates as the guard pipe 1 vibrates, the vibration energy of the guard pipe 1 is absorbed (damped) by virtue of the viscous resistance of the round rod body 12. Consequently, the amplitude resulting when the guard pipe 1 vibrates is reduced effectively.

### Embodiment 2

A rod-like unexpanded urethane resin material, instead of the round rod body 12 of the rubber material, may be inserted in to the interior of the straight pipe material 11 before the pipe material 11 is worked. In this case, instead of the round rod body 12 shown in FIG. 2, an unexpanded urethane resin material, which is formed into a rod-like shape having a suitable thickness, is inserted into the pipe material 11, and in this state, a pressing process, bending process and painting process are performed sequentially in that order as has been done in the previous embodiment. Thereafter, when the pipe material so processed is heated in a baking booth, the urethane resin material expands due to heat generated then, resulting in a state in which the urethane resin material 15 is filled within the pipe material 11 or the guard pipe 1 (refer to FIG. 5). In this case, it goes without saying that a resin should be selected which has an expanding temperature which is lower than the baking temperature used. According to the construction, the vibration energy of the guard pipe 1 is absorbed (damped) by the viscous resistance of the expanded urethane resin material 15.

The guard pipe according to the invention is not limited to the protection member for the fuel tank as illustrated in the aforesaid embodiments, and can be equally applied to a protection member for a muffler or a differential. In addition, according to the invention, since the vibration damping material can easily be provided within the pipe, the invention can be widely applied as a vibration controlling unit not only to the protection members but also to members made up of a pipe material.

1. An automotive guard pipe disposed next to a structure provided underneath a floor of a vehicle body in order to protect the structure from touching the ground, comprising:
a main portion,
bolt fastening portions formed at ends of the main portion, and
a vibration damping material inserted in the interior of a pipe material before the pipe material is worked.

2. The automotive guard pipe as set forth in claim 1, wherein
the vibration damping material includes a rod-like body of a rubber material which has an outside diameter substantially equal to an inside diameter of the pipe material.

3. The automotive guard pipe as set forth in claim 1, wherein
the vibration damping material is an unexpanded resin material having a quality that the resin material expands sufficiently when heated in a paint baking process for the guard pipe.

4. The automotive guard pipe as set forth in claim 1, further comprising:
sealers provided formed at ends of the main portion.
